(19) United States
(12) Patent Application Publication
(10) Pub. No.: US 2014/0028194 A1
(43) Pub. Date: Jan. 30, 2014

(54) DETECTION CIRCUIT AND DETECTION METHOD

(71) Applicant: TOSHIBA LIGHTING & TECHNOLOGY CORPORATION, Kanagawa (JP)

(72) Inventors: Noriyuki KITAMURA, Kangawa (JP); Toru ISHIKITA, Kanagawa (JP); Toshihiko SASAI, Kanagawa (JP); Hirokazu OTAKE, Kanagawa (JP); Yuji TAKAHASHI, Kanagawa (JP); Hiroshi AKAHOSHI, Kanagawa (JP)

(73) Assignee: Toshiba Lighting & Technology Corporation, Kanagawa (JP)

(21) Appl. No.: 13/664,090

(22) Filed: Oct. 30, 2012

(30) Foreign Application Priority Data
Jul. 27, 2012 (JP) 2012-167631

(51) Int. Cl. H05B 37/02

(52) U.S. Cl. 315/127

(57) ABSTRACT

A detection circuit according to embodiments includes a first circuit and a second circuit. The first circuit is turned OFF when an AC voltage to be input to a pair of input terminals is smaller than a prescribed value, and is turned ON when the AC voltage is equal to or higher than the prescribed value. The second circuit detects whether the AC voltage is an AC voltage leading-edge controlled by a dimmer, an AC voltage trailing-edge controlled by the dimmer, or an AC voltage having a continuous phase on the basis of at least one of the value of voltage and a gradient of the first circuit when the first circuit is turned ON while the first circuit is in the OFF state.

### CROSS-REFERENCE TO RELATED APPLICATIONS

This application is based upon and claims the benefit of priority from Japanese Patent Application No. 2012-167631, filed on Jul. 27, 2012; the entire contents of which are incorporated herein by reference.

### FIELD

Embodiments described herein relate generally to a detection circuit and a detection method.

### BACKGROUND

In recent years, replacement of lighting sources from incandescent lamps or fluorescent lamps to energy saving and long life light sources such as light-emitting diodes (LED) in luminaires is in progress. Also, for example, new lighting sources such as EL (Electro-Luminescence) or Organic light-emitting diode (OLED) are also developed.

A two-wire dimmer is configured to control the phase which turns triac ON, and is in widespread use as a dimmer of the incandescent lamp. Examples of such a dimmer include a configuration of a leading edge control that controls a phase which brings about conduction between a zero cross point and a maximum value of an AC voltage, and a configuration of a trailing edge control which controls a phase which brings about disconnection between the maximum value and a zero cross point. Therefore, the lighting source such as an LED is preferably dimmed by the dimmer of this type.

### BRIEF DESCRIPTION OF THE DRAWINGS

FIG. 1 is a circuit diagram illustrating a detection circuit according to a first embodiment;

FIG. 2 is a circuit diagram illustrating a dimmer configured to perform a leading edge control;

FIG. 3 is a circuit diagram illustrating a dimmer configured to perform a trailing edge control;

FIG. 4 is a waveform chart illustrating signals of a detection circuit when the dimmer is not provided;

FIGS. 5A and 5B are waveform charts illustrating signals of a detection circuit when the dimmer configured to perform the leading edge control is provided;

FIGS. 6A and 6B are waveform charts illustrating signals of a detection circuit when the dimmer configured to perform the trailing edge control is provided;

FIG. 7 is a circuit diagram illustrating a detection circuit according to a second embodiment; and

FIG. 8 is a circuit diagram illustrating a detection circuit according to a third embodiment.

### DETAILED DESCRIPTION

In general, according to one embodiment, a detection circuit includes a first circuit and a second circuit. The first circuit is configured to be turned OFF when an AC voltage to be input to a pair of input terminals is smaller than a prescribed value, and turned ON when the AC voltage is equal to or higher than the prescribed value. The AC voltage is leading-edge controlled by a dimmer, trailing-edge controlled by the dimmer, or has a continuous phase without passing through the dimmer. The second circuit is configured to detect whether the AC voltage is leading-edge controlled or trailing-edge controlled by the dimmer, or an AC voltage having a continuous phase on the basis of at least any one of a value or a gradient of the voltage of the first circuit when the first circuit is switched ON while the first circuit is in the OFF state.

Referring now to the drawings, an embodiment will be described in detail. In this specification of the application and respective drawings, the same components as those described relating to already presented drawing are designated by the same reference numerals and detailed description will be omitted as needed.

### First Embodiment

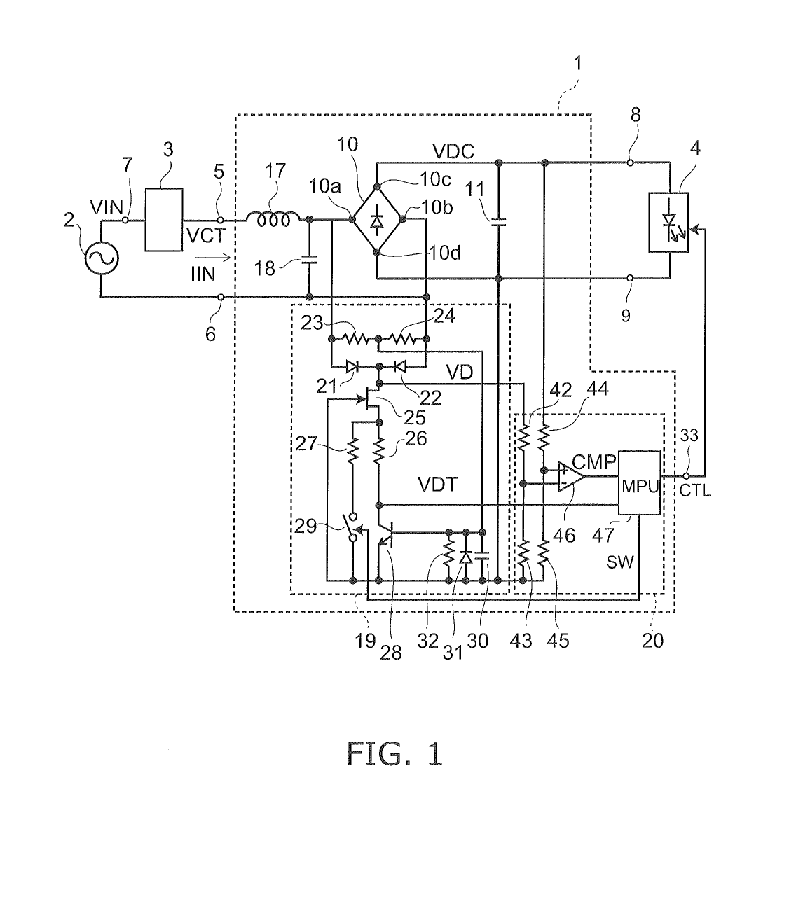

FIG. 1 is a circuit diagram illustrating a detection circuit according to a first embodiment.

A detection circuit 1 according to the first embodiment is used as an interface configured to receive an AC voltage VCT supplied from an AC power supply 2 via a dimmer 3 and output a DC voltage VDC and a detection signal CTL indicating the presence or absence and the type of the dimmer 3 to, for example, a luminaire 4. The luminaire 4 includes, for example, a lighting source such as a light-emitting diode (LED), and receives a supply of power from the AC power supply 2 via the detection circuit 1 to turn ON. The luminaire 4 may be dimmed by the dimmer 3 via the detection circuit 1. In the first embodiment, a configuration in which the detection signal CTL is supplied to the luminaire 4 is exemplified. However, a configuration in which the detection signal CTL is not supplied to the luminaire 4 is also applicable.

The AC power supply 2 is, for example, a commercial power supply. In the first embodiment, a configuration in which the dimmer 3 is inserted in series between terminals 5 and 7 of one of a pair of power-supply lines that supply a power-supply voltage VIN. However, other configurations are also applicable. A configuration in which the dimmer 3 is not employed is also applicable.

Types of the dimmer 3 generally include a leading edge control system that controls a phase which brings about conduction in a period from a zero cross point to a point where an absolute value of the AC voltage becomes the maximum and a trailing edge control system that controls a phase which brings about disconnection during a period from a point where the absolute value of the AC voltage becomes the maximum to a zero cross point.

The dimmer configured to perform the leading edge control has a simple circuit configuration, and is capable of handling a relatively large power load. However, when a triac is used, the dimmer configured to perform the leading edge control has a difficulty to perform a light load operation, and if the so-called power supply dip which is a temporary drop of the power-supply voltage occurs, an unstable operation may result. The dimmer configured to perform the leading edge control is also characterized by being incompatible with the capacitive load when a capacitive load is connected, because an incoming current is generated.

In contrast, the dimmer configured to perform the trailing edge control is operable with a light load, does not generate the incoming current even when the capacitive load is connected, and is stable in operation even though the power supply dip occurs. However, the dimmer of this type has a complex circuit configuration and is not suitable for a heavy load because the temperature rises easily. The dimmer configured to perform the trailing edge control is also characterized in that a surge occurs when an inductive load is connected.

When a low-impedance element such as an incandescent lamp or the like is connected as a load of the dimmer, an electric current flows in all the phases of the AC voltage, and hence erroneous operations of the dimmer do not occur. However, when a lighting circuit which turns ON the lighting source such as the LED is connected as the load of the dimmer, the input impedance varies with the phase of the AC voltage, and hence the erroneous operations of the dimmer may occur. Consequently, the lighting circuit is provided with a circuit which passes an electric current to the dimmer, for example, depending on the presence or the absence of the dimmer and if the dimmer is connected, depending on the types of the dimmer whether it performs the leading edge control or the trailing edge control.

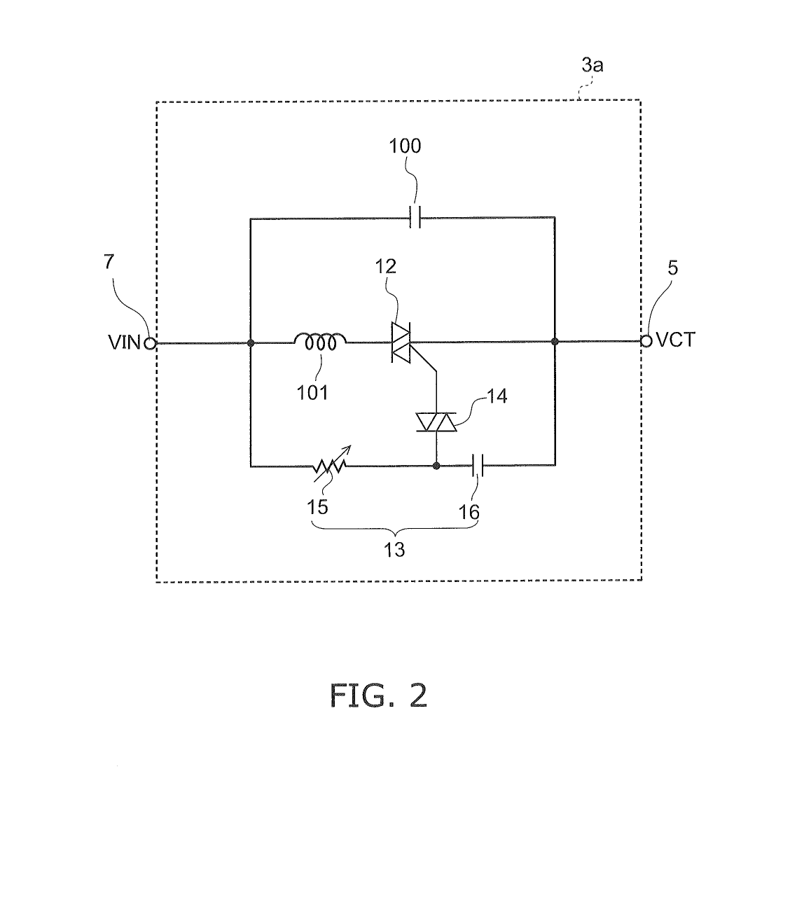

FIG. 2 is a circuit diagram illustrating a dimmer configured to perform a leading edge control.

A dimmer 3a includes a triac 12 inserted in series into the power-supply line, an inductor 101 connected in series with the triac 12, a phase circuit 13 connected in parallel to a series circuit of the triac 12 and the inductor 101, a diac 14 connected between a gate of the triac 12 and the phase circuit 13, and a filter capacitor 100 connected in parallel to a series circuit of the triac 12 and the inductor 101.

The triac 12 is normally in disconnected state between main electrodes, and is brought into conduction when a pulse signal is input to the gate. The triac 12 is capable of allowing a current to flow in both directions when the AC power-supply voltage VIN has either a positive polarity or a negative polarity.

The phase circuit 13 includes a variable resistance 15 and a timing capacitor 16, and generates a voltage at both ends of the timing capacitor 16 delayed in phase. When the value resistance of the variable resistance 15 is varied, a time constant varies and a delay time varies.

The diac 14 generates a pulse voltage when the voltage to be charged in the capacitor of the phase circuit 13 exceeds a certain value, and brings the triac 12 into conduction.

The dimmer 3a is capable of adjusting timing when the triac 12 conducts by controlling the timing when the diac 14 generates pulses by varying the time constant of the phase circuit 13. Therefore, the dimmer 3a is capable of adjusting a conducting period of the leading edge control of the AC voltage VCT.

The inductor 101 reduces a change rate di/dt of an electric current i for preventing the triac 12 from being destroyed. The filter capacitor 100 is provided for preventing a noise as a filter of the inductor 101.

As regards a range which allows the leading edge control is, for example, the minimum width is 10% to 25% of half a cycle of the power-supply voltage VIN. For example, when the AC power supply 2 is a commercial power supply of 50 Hz in frequency, the half cycle is 10 ms, and the minimum time width is 1 ms to 2.5 ms. An absolute value of the AC voltage VCT passing through the dimmer 3a is on the order of 25% to 65% of a maximum value as a peak voltage. For example, when the AC power supply 2 is a commercial power supply of 100 V in effective value, the peak voltage is 141 V and an AC voltage VCT which can be generated is 30 V to 90 V.

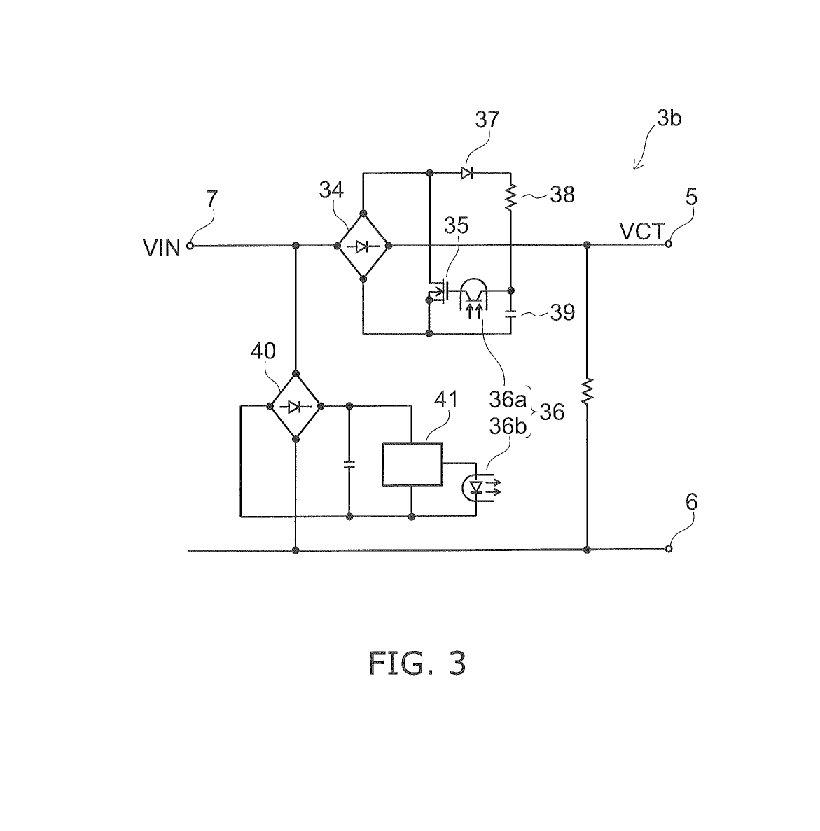

FIG. 3 is a circuit diagram illustrating a dimmer configured to perform the trailing edge control.

A dimmer 3b includes rectification circuits 34 and 40, a semiconductor switch 35, a photo coupler 36, a diode 37, a resistance 38, a capacitor 39, and a dimming control circuit 41.

The rectification circuit 34 is inserted in series in one of the pair of power-supply lines. The semiconductor switch 35 is, for example, an FET, and is connected between a pair of output terminals of the rectification circuit 34. The diode 37, the resistance 38, and the capacitor 39 are connected in series between the pair of output terminals of the rectification circuit 34, which constitutes a bias circuit which brings the semiconductor switch 35 into conduction.

The photo coupler 36 includes a light-receiving element 36a and a light-emitting element 36b, and the light-receiving element 36a is connected between the control terminal (gate) of the semiconductor switch 35 and the capacitor 39 which constitutes the bias circuit. When the light-receiving element 36a of the photo coupler 36 is brought into conduction, the voltage of the capacitor 39 is applied to the control terminal of the semiconductor switch 35.

The rectification circuit 40 is connected in parallel to the pair of power-supply lines. The dimming control circuit 41 is connected between the pair of output terminals of the rectification circuit 40. The light-emitting element 36b of the photo coupler 36 is connected to an output of the dimming control circuit 41. When the light-emitting element 36b emits light, the light-receiving element 36a is brought into conduction, and the voltage of the capacitor 39 is applied to the control terminal of the semiconductor switch 35. Consequently, the semiconductor switch 35 is brought into conduction, and hence the dimmer 3b is brought into the conduction state. When the light-emitting element 36b does not emit light, the light-receiving element 36a is disconnected and the semiconductor switch 35 is disconnected, so that the dimmer 3b is brought into the disconnected state.

The dimming control circuit 41 is composed of, for example, a microcomputer or a microprocessor (MPU), and is configured to dim light by adjusting the timing to emit light of the light-emitting element 36b, and controlling a conduction period TON of the leading edge control of the input power-supply voltage VIN.

As regards a range which allows the trailing edge control is, for example, the minimum width is 10% to 35% of half a cycle of the power-supply voltage VIN. For example, when the AC power supply 2 is a commercial power supply of 50 Hz in frequency, the half cycle is 10 ms, and the minimum time width is 1 ms to 3.5 ms.

Returning back to FIG. 1 again, the detection circuit 1 includes a rectification circuit 10, a smoothing capacitor 11, a choke coil 17, a capacitor 18, a first circuit 19 and a second circuit 20.

The rectification circuit 10 is composed of a diode bridge. Input terminals 10a and 10b of the rectification circuit 10 are connected to a pair of input terminals 5 and 6 via the choke coil 17. The AC voltage VCT leading-edge controlled or trailing-edge controlled via the dimmer 3 is input to the input terminals 10a and 10b of the rectification circuit 10. Although a configuration employing the dimmer 3 is described in the first embodiment, a configuration employing the dimmer 3a or 3b is also applicable, and a configuration in which the dimmer is not provided is also applicable.

The smoothing capacitor 11 is connected to a high-potential terminal 10c and a low-potential terminal 10d of the rectification circuit 10, and a smoothed DC voltage VDC is generated at the ends of the smoothing capacitor 11. The DC voltage VDC is output from output terminals 8 and 9 as an output voltage of the detection circuit 1. The rectification circuit 10 may have any suitable configuration as long as the AC voltage VCT input from the dimmer 3 is rectified.

The first circuit 19 includes a pair of rectification elements 21 and 22, a pair of resistances 23 and 24, a switching element 25, resistances 26, 27 and 32, a transistor 28, a switch 29, a capacitor 30, and a diode 31.

The pair of rectification elements 21 and 22 are, for example, diodes, and anodes of the rectification elements 21 and 22 are connected to the pair of input terminals 5 and 6 via the choke coil 17. Respective cathodes of the pair of rectification elements 21 and 22 are connected each other, and the pair of rectification elements 21 and 22 are connected to the pair of input terminals 5 and 6 so as to be in series in the direction of reverse conduction. The pair of resistances 23 and 24 are connected in series to the pair of input terminals 5 and 6 via the choke coil 17. The value of resistance of the resistances 23 and the value of resistance of the resistances 24 are set to be equal to each other.

The switching element 25 is, for example, an FET, for example, GaN-HENT, and is a normally-on type element. A drain of the switching element 25 is connected to a cathode of the rectification element 21 and a cathode of the rectification element 22, and a source of the switching element 25 is connected to one end of the resistance 26 and one end of resistance 27, and a gate of the switching element 25 is connected to the low-potential terminal 10d.

The other end of the resistance 26 is connected to the low-potential terminal 10d of the rectification circuit 10 via the transistor 28. The transistor 28 is an NPN transistor. A collector of the transistor 28 is connected to the other end of the resistance 26, an emitter of the transistor 28 is connected to the low-potential terminal 10d of the rectification circuit 10, and a base of the transistor 28 is connected to a connecting point between the pair of resistances 23 and 24.

The other end of the resistance 27 is connected to the low-potential terminal 10d of the rectification circuit 10 via the switch 29. The value of resistance of the resistance 27 is set to be larger than the value of resistance of the resistance 26. The switch 29 is, for example, an FET, and is switched between ON and OFF by a switch signal SW.

The capacitor 30, the diode 31 and a resistance 32 are connected to the base of the transistor 28 and the low-potential terminal 10d of the rectification circuit 10 in parallel.

The first circuit 19 is connected to the pair of input terminals 5 and 6 via the pair of rectification elements 21 and 22 and the pair of resistances 23 and 24, and is configured to be symmetry with respect to the pair of input terminals 5 and 6.

The second circuit 20 includes resistances 42 to 45, a comparing circuit 46, and a microprocessor (MPU) 47. The resistances 42 and 43 are connected to cathodes of the rectification elements 21 and 22 and a drain of the switching element 25, and the low-potential terminal 10d of the rectification circuit 10 in series, and divide a drain voltage of the switching element 25. The resistances 44 and 45 are connected to the output terminals 8 and 9 in series and divide the DC voltage VDC.

An inverting input terminal (−) of the comparing circuit 46 is connected to a connecting point between the resistance 42 and the resistance 43. A non-inverting input terminal (+) of the comparing circuit 46 is connected to a connecting point between the resistance 44 and the resistance 45. An output terminal of the comparing circuit 46 is connected to the microprocessor 47.

The microprocessor 47 inputs an output voltage of the comparing circuit 46 and a collector voltage VDT of the transistor 28 and outputs the switch signal SW which turns the switch 290N or OFF and the detection signal CTL detecting the presence or absence of the dimmer 3 and the type of the dimmer 3. The detection signal CTL is input to the luminaire 4 via an output terminal 33 of the detection circuit 1.

Subsequently, operations of the detection circuit 1 will be described in the order of a case where the dimmer is not provided, a case where the dimmer 3a that performs the leading edge control is provided, and a case where the dimmer 3b that performs the trailing edge control is provided.

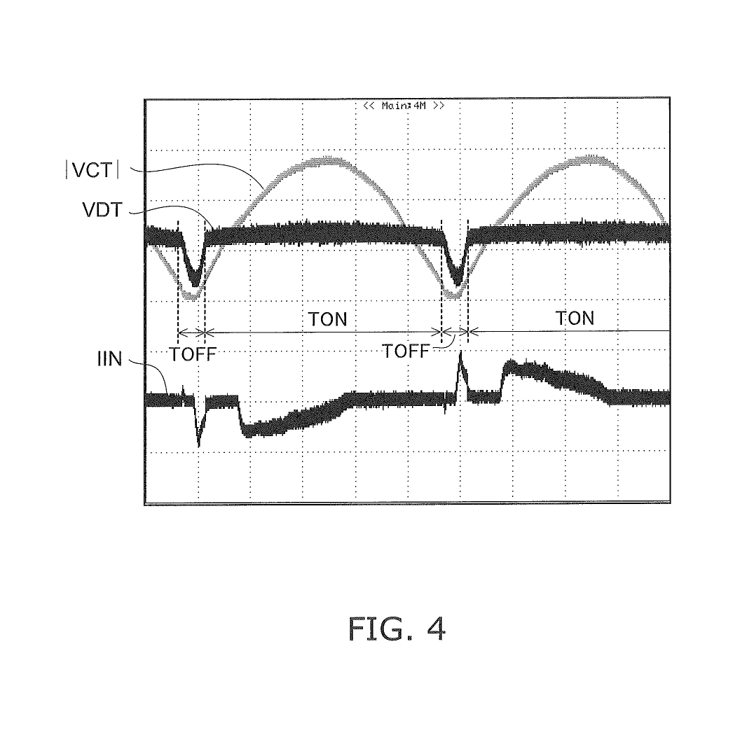

FIG. 4 is a waveform chart illustrating signals of a detection circuit when the dimmer is not provided.

In FIG. 4, an absolute value |VCT| of AC voltage VCT input to the detection circuit 1, a conduction detection signal VDT, and an input current IIN are illustrated. Since the embodiment has a configuration in which the dimmer is not provided, the AC voltage VCT input to the detection circuit 1 is equal to the power-supply voltage VIN of the AC power supply 2.

The AC power supply 2 is a commercial power supply of a frequency of 50 Hz and a voltage of 100 V. It is assumed that the power-supply voltage VIN of the AC power supply 2 is zero-crossed and, for example, the power-supply voltage VIN has a phase in which the input terminal 5 side has a positive polarity and the input terminal 6 side has a negative polarity. The AC voltage VCT (=VIN) is supplied to a drain of the switching element 25 via rectification element 21. The switching element 25 is a normally-on type element and hence is in the ON state.

The rectification element 22 is in the disconnected state. The voltages at both ends of the resistances 24 are higher than voltages at both ends of the resistance 32 connected between the base and the emitter of the transistor 28. Consequently, the input terminal 10b and the low-potential terminal 10d of the rectification circuit 10 are brought into conduction.

The absolute value |VCT| of AC voltage VCT input to the input terminals 5 and 6 of the detection circuit 1 is relatively small, and the base voltage of the transistor 28 obtained by dividing the AC voltage VCT by the resistances 23 and the resistance 32 is lower than a forward voltage between the base and the emitter of the transistor 28. Consequently, the transistor 28 is in the OFF state. Since the transistor 28 is in the OFF state, the conduction detection signal VDT as the collector voltage of the transistor 28 is equal to the source voltage of the switching element 25, and varies in accordance with the AC voltage VCT.

The MPU 47 detects that the conduction detection signal VDT is smaller than a prescribed value, and outputs, for example, the switch signal SW to turn the switch 290N. Consequently, the input current IIN flows along a route of the input terminal 5, the choke coil 17, the rectification element 21, the switching element 25, the resistance 27, the switch 29, the rectification circuit 10, and the input terminal 6. The MPU 47 may output the switch signal SW to turn the switch 29 OFF after having detected that the dimmer is not connected.

Subsequently, when the absolute value of the power-supply voltage VIN increases, the drain voltage of the switching element 25 increases, and the voltage between the base and the emitter of the transistor 28 of the first circuit 19 increases. When the absolute value of the AC voltage VCT input into the input terminals 5 and 6 is increased to a level equal to or larger than the predetermined value, the transistor 28 of the first circuit 19 is turned ON. Consequently, the conduction detection signal VDT as the collector voltage of the transistor 28 is clamped by an ON voltage of the transistor 28, and becomes a constant value.

Here, the term “prescribed value” means a voltage that the first circuit 19 detects the conducting state and the disconnected state of the AC voltage VCT. When the absolute value of the AC voltage VCT is smaller than the prescribed value, the first circuit 19 detects the disconnected state, and when the absolute value of the AC voltage VCT is equal to or larger than the prescribed value, the first circuit 19 detects the conducting state. The prescribed value is a voltage value which is, for example, 15% of a maximum instantaneous value of the power-supply voltage VIN of the AC power supply 2 and, for example, when the effective value is 100 V, the prescribed value is 21 V as 15% of the maximum instantaneous value 141 V. As described with reference to FIG. 2, the AC voltage VCT that the dimmer 3a configured to perform the leading edge control can generate is 30 V to 90 V, and hence the prescribed value may be defined, for example, to be approximately 20 V.

The voltage obtained by dividing the drain voltage of the switching element 25, the voltage obtained by dividing the smoothed DC voltage VDC, and a comparing signal CMP as a result of comparison by the comparing circuit 46 are input to the MPU 47. Since the dimmer is not provided in the embodiment, the prescribed value as the voltage that the AC voltage VCT conducts is lower than the DC voltage VDC, and the comparing signal CMP is at a low level. Therefore, the MPU 47 inputs the low level as the comparing signal CMP and holds the same synchronously with a rising edge from the low level to the high level that the conduction detection signal VDT rises.

The MPU 47 obtains the time width of a low-level period TOFF of the conduction detection signal VDT synchronously with the rising edge of the conduction detection signal VDT, and starts measurement of a high-level period TON simultaneously. Here, the low-level period TOFF of the conduction detection signal VDT is a period in which the first circuit 19 is in the OFF state and the high-level period TON of the conduction detection signal VDT is a period in which the first circuit 19 is in the ON state.

When the phase of the AC voltage VCT advances with time, the AC voltage VCT reaches the maximum value and lowers gradually. The conduction detection signal VDT is clamped to a constant value while the absolute value of the AC voltage VCT is equal to or larger than the prescribed value.

When the absolute value of the AC voltage VCT is reduced to a level smaller than the prescribed value, the transistor 28 is turned OFF. When the absolute value of the AC voltage VCT is reduced, the conduction detection signal VDT is reduced.

The MPU 47 obtains the time width of a high-level period TON of the conduction detection signal VDT synchronously with the falling edge of the conduction detection signal VDT and, simultaneously, starts measurement of the low-level period TOFF of the conduction detection signal VDT.

When the AC voltage VCT crosses zero and the polarity of the AC voltage VCT is inverted so that the input terminal 5 side becomes the negative polarity and the input terminal 6 side becomes the positive polarity, the rectification element 21 is turned OFF. The operations in this case are the same as described above except that the operations of the rectification elements 21 and 22 and the operations of the resistances 23 and 24 are replaced each other.

Subsequently, when the AC voltage VCT crosses zero and the polarity of the AC voltage VCT is inverted so that the input terminal 5 side becomes the positive polarity and the input terminal 6 side becomes the negative polarity, the rectification element 22 is returned back to the OFF state, and the same operations are repeated from then onward.

In the embodiment, since the dimmer is not provided, the AC voltage VCT is subject to a substantially sinusoidal variation with respect to the phase. Therefore, the low-level period TOFF of the conduction detection signal VDT is shorter than the case where the dimmer is provided.

The input current IIN flows when the polarity of the AC voltage VCT is changed and when the smoothing capacitor 11 is charged.

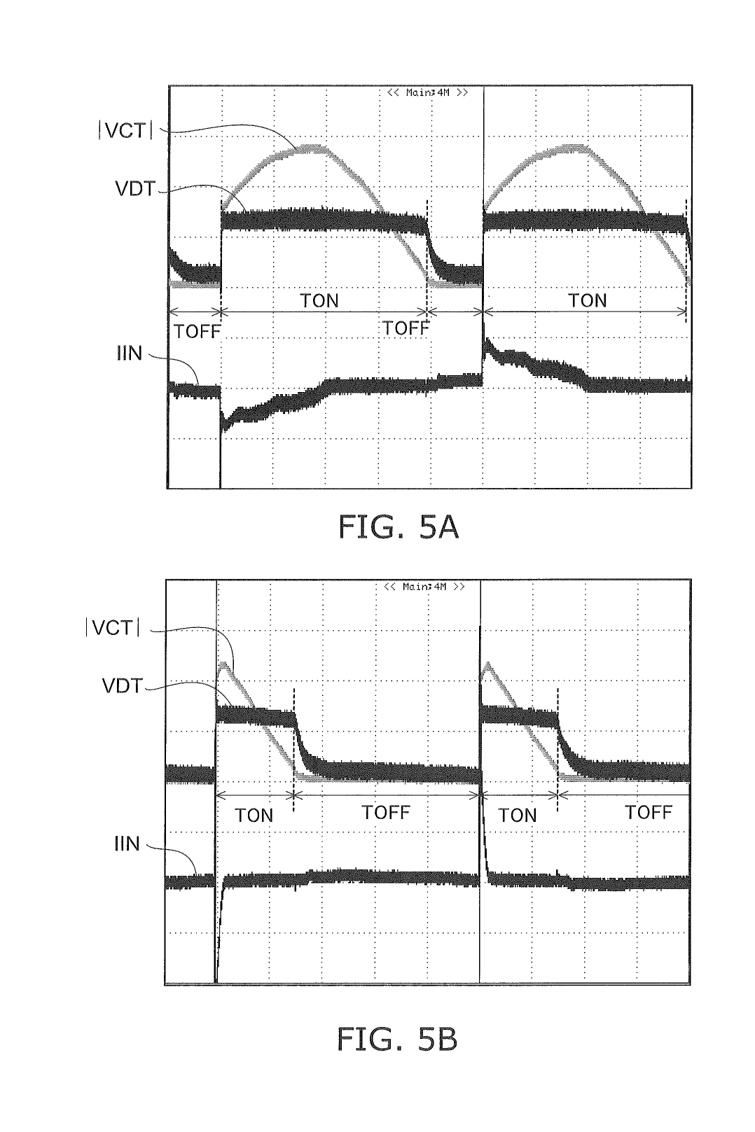

FIGS. 5A and 5B are waveform charts illustrating signals of a detecting circuit when the dimmer 3a configured to perform the leading edge control is provided, and FIG. 5A shows a case where the conducting period is long, and FIG. 5B shows a case where the conduction period is short.

In FIGS. 5A and 5B, an absolute value |VCT| of AC voltage VCT input to the detection circuit 1, a conduction detection signal VDT, and an input current IIN are illustrated. Since the embodiment has a configuration having the dimmer 3a which performs the leading edge control, the AC voltage VCT input to the detection circuit 1 is equal to the power-supply voltage VIN of the AC power supply 2 when the dimmer 3a is in the conducting state. The AC power supply 2 is a commercial power supply of a frequency of 50 Hz and a voltage of 100 V.

It is assumed that the power-supply voltage VIN of the AC power supply 2 is zero-crossed and, for example, the power-supply voltage VIN has a phase in which the input terminal 5 side has a positive polarity and the input terminal 6 side has a negative polarity. Since the dimmer 3a is in the disconnected state, the absolute value of the AC voltage VCT is still small, and the power-supply voltage VIN is applied to the dimmer 3a.

The operations of the first circuit 19 are the same as the case where the absolute value of the AC voltage VCT in the case where the dimmer described with reference to FIG. 4 is not provided is smaller than the prescribed value. The transistor 28 is in the OFF state, and the conduction detection signal VDT is at a low level which is substantially the same as the absolute value of the AC voltage VCT. The MPU 47 measures the low-level period of the conduction detection signal VDT.

If the absolute value of the power-supply voltage VIN of the AC power supply 2 increases and the dimmer 3a is brought into conduction, the AC voltage VCT becomes substantially the same as the power-supply voltage VIN. Consequently, the absolute value of the AC voltage VCT increases to a level equal to or higher than the prescribed value, the transistor 28 is turned ON, and the conduction detection signal VDT is clamped by the ON voltage of the transistor 28 and becomes a constant value.

In the embodiment, since the dimmer 3a which performs the leading edge control is provided, the absolute value of the AC voltage VCT when the conduction detection signal VDT rises is larger than the prescribed value and is substantially the same as the DC voltage VDC. Therefore, the MPU 47 inputs the high level as the comparing signal CMP synchronously with a rising edge of the conduction detection signal VDT and hold the input.

The MPU 47 obtains the time width of the low-level period TOFF of the conduction detection signal VDT synchronously with the rising edge of the conduction detection signal VDT and, simultaneously, starts measurement of the high-level period TON.

When the phase of the AC voltage VCT advances with time, the AC voltage VCT reaches the maximum value and lowers gradually. The conduction detection signal VDT is clamped to a constant value while the absolute value of the AC voltage VCT is equal to or larger than the prescribed value.

When the absolute value of the AC voltage VCT is reduced to a level smaller than the prescribed value, the transistor 28 is turned OFF. When the absolute value of the AC voltage VCT is reduced, the conduction detection signal VDT is reduced.

The MPU 47 obtains the time width of the high-level period TON of the conduction detection signal VDT synchronously with the falling edge of the conduction detection signal VDT and, simultaneously, starts measurement of the low-level period TOFF of the conduction detection signal VDT.

When the AC voltage VCT crosses zero and the polarity of the AC voltage VCT is inverted so that the input terminal 5 side becomes the negative polarity and the input terminal 6 side becomes the positive polarity, the rectification element 21 is turned OFF. The operations in this case are the same as described above except that the operations of the rectification elements 21 and 22 and the operations of the resistances 23 and 24 are replaced each other.

When the AC voltage VCT crosses zero and the polarity of the AC voltage VCT is inverted so that the input terminal 5 side becomes the positive polarity and the input terminal 6 side becomes the negative polarity, the rectification element 22 is returned back to the OFF state, and the same operations are repeated from then onward.

In the embodiment, since the dimmer 3a which performs the leading edge control is provided, the absolute value of the AC voltage VCT rises abruptly in the phase where the dimmer 3a is brought into conduction. Therefore, the low-level period TOFF of the conduction detection signal VDT is longer than the case where the dimmer is not provided.

The input current IIN flows when the smoothing capacitor 11 is charged.

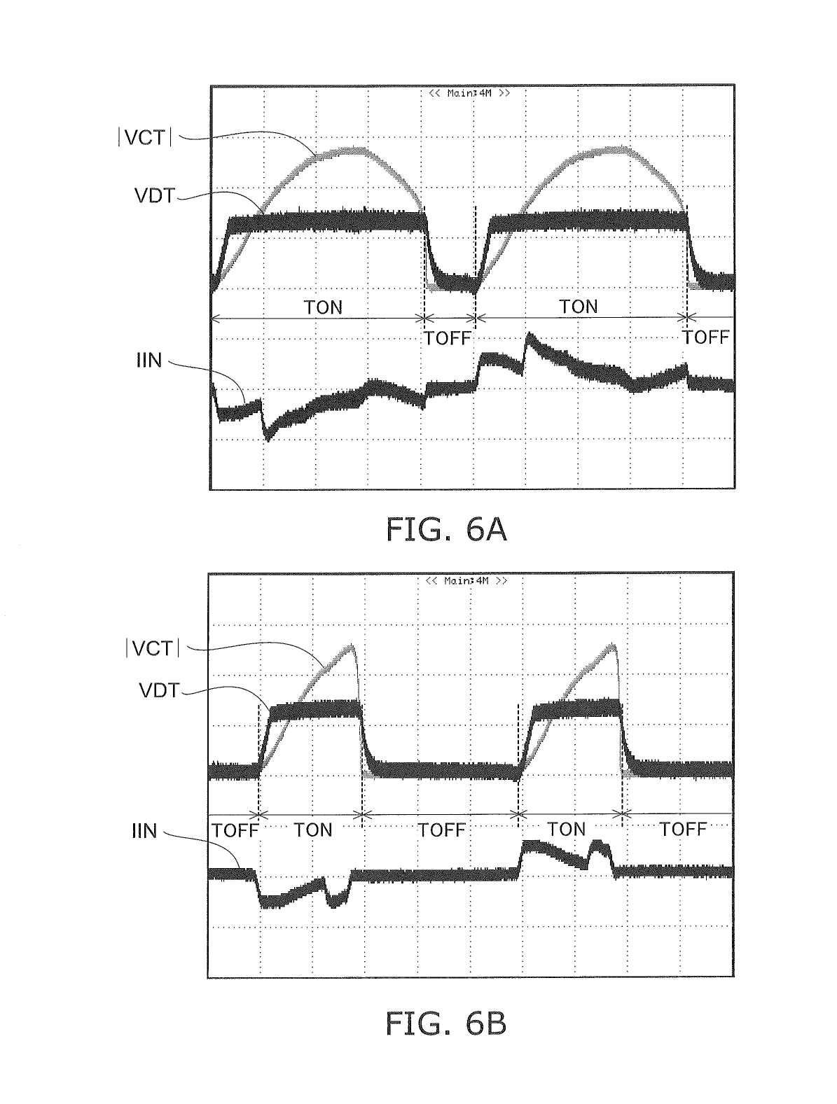

FIGS. 6A and 6B are waveform charts illustrating signals of a detection circuit when the dimmer 3b configured to perform the trailing edge control is provided, and FIG. 6A shows a case where the conducting period is long, and FIG. 6B shows a case where the conduction period is short.

In FIGS. 6A and 6B, the absolute value |VCT| of AC voltage VCT input to the detection circuit 1, the conduction detection signal VDT, and the input current IIN are illustrated. Since the embodiment has a configuration having the dimmer 3b which performs the trailing edge control, the AC voltage VCT input to the detection circuit 1 is equal to the power-supply voltage VIN of the AC power supply 2 when the dimmer 3a is in the conducting state. The AC power supply 2 is a commercial power supply of a frequency of 50 Hz and a voltage of 100 V.

Operations to be performed from a state in which the power-supply voltage VIN of the AC power supply 2 is zero-crossed and, for example, the power-supply voltage VIN has a phase in which the input terminal 5 side has a positive polarity and the input terminal 6 side has a negative polarity until when the absolute value of the power-supply voltage VIN rises to the maximum value are the same as the case where the dimmer described with reference to FIG. 4 is not provided.

The MPU 47 inputs the low level as the comparing signal CMP synchronously with a rising edge of the conduction detection signal VDT and holds the input.

When the phase of the AC voltage VCT advances with time, the AC voltage VCT reaches the maximum value and lowers gradually. The conduction detection signal VDT is clamped to a constant value while the absolute value of the AC voltage VCT is equal to or larger than the prescribed value.

When the dimmer 3b is brought into the disconnected state, the absolute value of the AC voltage VCT is lowered to a level smaller than the prescribed value. Consequently, the transistor 28 is turned OFF. If the absolute value of the AC voltage VCT is reduced with the power-supply voltage VIN, the conduction detection signal VDT is reduced to a low level.

The MPU 47 obtains the time width of a term TON in which the conduction detection signal VDT is at a high level synchronously with the falling edge of the conduction detection signal VDT and, simultaneously, starts measurement of the low-level period TOFF.

When the AC voltage VCT crosses zero and the polarity of the AC voltage VCT is inverted so that the input terminal 5 side becomes the negative polarity and the input terminal 6 side is in the positive polarity, the rectification element 21 is turned OFF. The operations in this case are the same as described above except that the operations of the rectification elements 21 and 22 and the operations of the resistances 23 and 24 are replaced each other.

Subsequently, when the AC voltage VCT crosses zero and the polarity of the AC voltage VCT is inverted so that the input terminal 5 side becomes the positive polarity and the input terminal 6 side becomes the negative polarity, the rectification element 22 is returned back to the OFF state, and the same operations are repeated from then onward.

Since the dimmer 3b configured to perform the trailing edge control is provided in the first embodiment, the low-level period TOFF of the conduction detection signal VDT is longer than the case where the dimmer is not provided.

The input current IIN flows when the polarity of the AC voltage VCT is changed and when the smoothing capacitor 11 is charged.

As described with reference to FIG. 2, in the dimmer 3a configured to perform the leading edge control, the minimum width of the low-level period TOFF of the conduction detection signal VDT is 10% to 25% of the cycle of the AC voltage VCT (half the cycle of the power-supply voltage VIN). When the frequency of the AC power supply 2 is 50 Hz, the half cycle is 10 ms, and the minimum time width becomes, for example 1 ms to 2.5 ms. As described with reference to FIG. 3, in the dimmer 3b configured to perform the trailing edge control, the minimum width of the low-level period TOFF of the conduction detection signal VDT is 10% to 35% of the cycle of the AC voltage VCT (half the cycle of the power-supply voltage VIN). When the frequency of the AC power supply 2 is 50 Hz, the minimum time width becomes, for example 1 ms to 2.5 ms.

Therefore, the presence or the absence of the dimmer is detected by determining, for example, the low-level period TOFF of the conduction detection signal VDT with respect to the value when the dimmer is not provided with a threshold value of 0.5 ms.

As described above, by latching the comparing signal CMP synchronously with the rising edge of the conduction detection signal VDT, the type of the dimmer may be detected. When the dimmer 3a configured to perform the leading edge control is used, a high level is latched as the comparing signal CMP. When the dimmer is not provided or the dimmer 3b configured to perform the trailing edge control is used, a low level is latched as the comparing signal CMP.

The MPU 47 detects the presence or the absence of the dimmer and the type of the dimmer, and outputs the detection signal CTL.

The detection circuit of the first embodiment detects the presence or the absence of the dimmer by measuring the time width between the rising edge and the falling edge of the conduction detection signal VDT, and detects the type of the dimmer by latching the comparing signal CMP synchronously with the rising edge of the conduction detection signal VDT. Consequently, in comparison with a case where the AC voltage VCT is sampled by an amount corresponding to one cycle for processing, required storage capacity and throughput are reduced.

In FIG. 1, the configuration in which the MPU is used as the second circuit 20 has been described as an embodiment. However, the second circuit 20 may be configured with a latch circuit configured to latch at an edge of the conduction detection signal VDT, a counter configured to measure the time between the edges of the conduction detection signal VDT, and the like.

### Second Embodiment

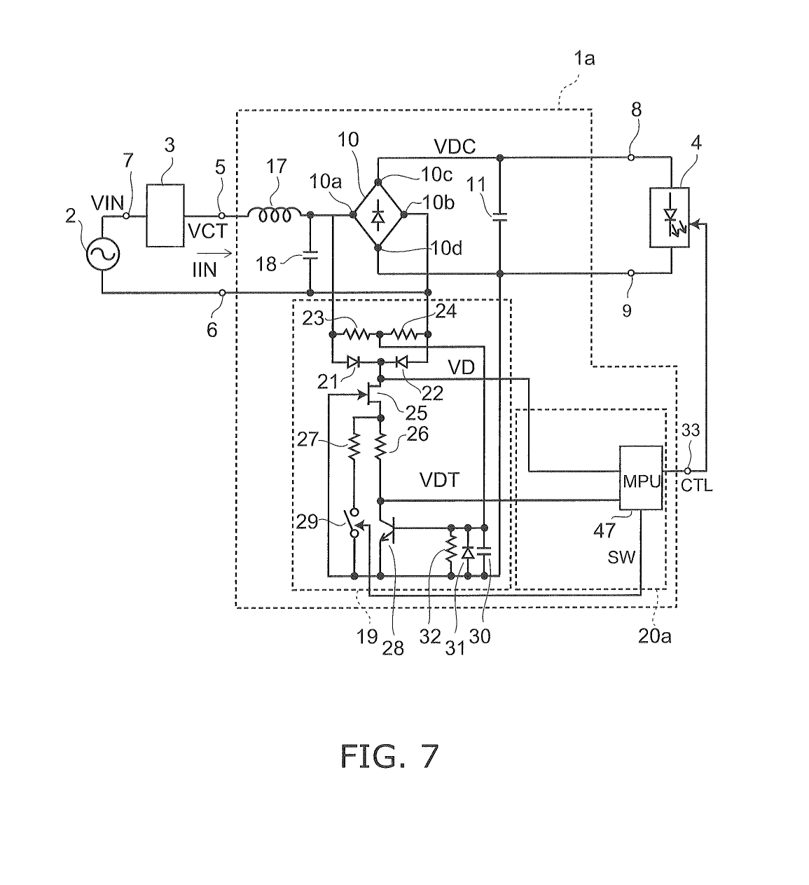

FIG. 7 is a circuit diagram illustrating a detection circuit according to a second embodiment.

In a detection circuit 1a of the embodiment, a second circuit 20a is provided instead of the second circuit 20 in the detection circuit 1 of the first embodiment. The configurations other than the second circuit 20a of the detection circuit 1a are the same as the configurations of the detection circuit 1.

The second circuit 20a has a configuration in which the resistances 42 to 45 and the comparing circuit 46 are eliminated from the second circuit 20 and a drain voltage of the switching element 25 is input to the MPU 47. The collector voltage of the transistor 28 of the first circuit 19 is input to the MPU as the conduction detection signal VDT.

The MPU 47 of the second circuit 20a inputs the drain voltage VD of the switching element 25 as an absolute value of the AC voltage VCT, and obtains a gradient dVD/dt at the rising edge of the conduction detection signal VDT.

As illustrated in FIG. 4 to FIG. 6, the gradient dVD/dt at the rising edge of the conduction detection signal VDT when the dimmer is not provided and when the dimmer 3b configured to perform the trailing edge control is provided is smaller than the gradient dVD/dt at the rising edge of the conduction detection signal VDT when the dimmer 3a configured to perform the leading edge control is provided.

The second circuit 20a detects the type of the dimmer from the magnitude of the gradient dVD/dt at the rising edge of the conduction detection signal VDT. When the gradient dVD/dt is relatively large, the dimmer 3a configured to perform the leading edge control is detected, and when the gradient dVD/dt is relatively small, the dimmer 3b configured to perform the trailing edge control is detected.

In the embodiment, since the comparing circuit configured to compare the AC voltage VCT with the DC voltage VDC is not provided, the configuration is simplified and the circuit scale may be reduced. For example, when the AC voltage VCT is sampled by an amount corresponding to one cycle and the type of the dimmer is detected by obtaining the gradients dVCT/dt at all the phases, large storage capacity and amount of calculation are required. In contrast, in the embodiment, since the gradient dVD/dt at the rising edge of the conduction detection signal VDT is obtained, the required storage capacity and amount of calculation may be reduced.

### Third Embodiment

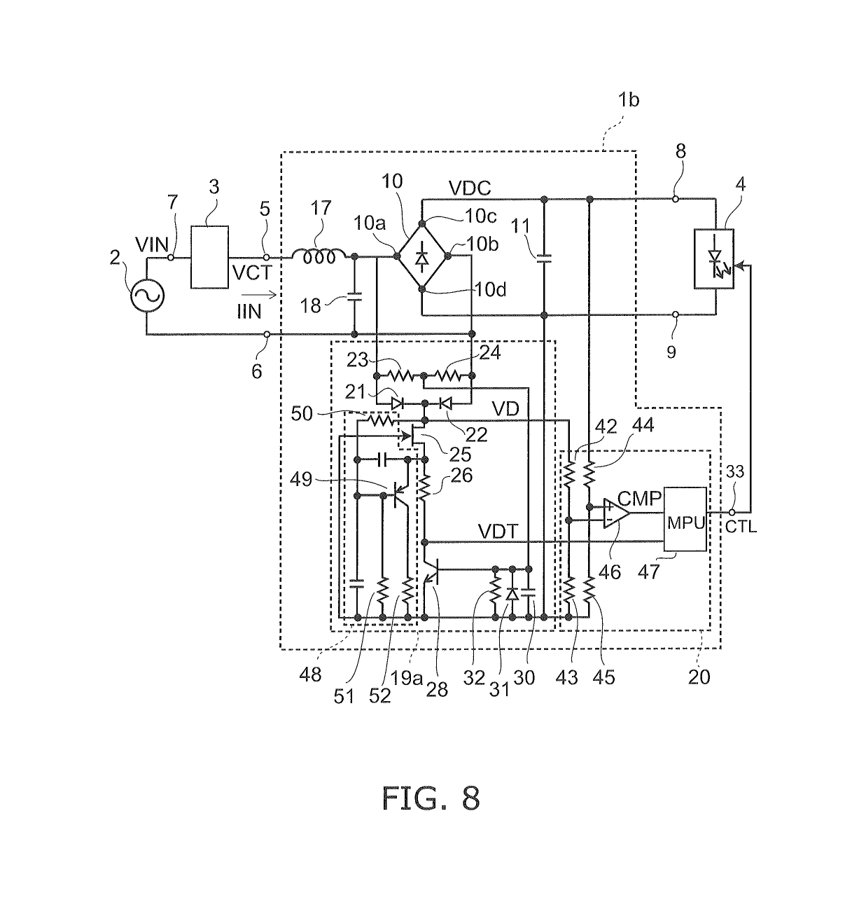

FIG. 8 is a circuit diagram illustrating a detection circuit according to a third embodiment.

In a detection circuit 1b of the embodiment, a first circuit 19a is provided instead of the first circuit 19 in the detection circuit 1 of the first embodiment. The configurations other than the first circuit 19a of the detection circuit 1b are the same as the configurations of the detection circuit 1.

The first circuit 19a is provided with a load circuit 48 instead of the load circuit composed of the resistance 27 and the switch 29 in the first circuit 19.

The load circuit 48 includes a transistor 49 and resistances 50 to 52. The transistor 49 is a PNP transistor. The emitter of the transistor 49 is connected to the source of the switching element 25, and the collector of the transistor 49 is connected to the low-potential terminal 10d of the rectification circuit 10 via the resistance 52. The base of the transistor 49 is connected to the drain of the switching element 25 via the resistance 50, and is connected to the low-potential terminal 10d of the rectification circuit 10 via the resistance 51.

When the AC voltage VCT is supplied to the input terminals 5 and 6, since the switching element 25 is a normally-on type element, an electric current flows through the transistor 49. Since the electric current flows even when the absolute value of the AC voltage VCT is smaller than the prescribed value, the current IIN may be flowed between the input terminals 5 and 6 even when the transistor 28 is in the OFF state. Consequently, the operations of the dimmer may be stabilized by causing the electric current to flow in all the phases even when the dimmer is connected. Since the input impedance of the detection circuit 1b may be lowered, the absolute value of the AC voltage VCT when the dimmer is in the disconnected state may be lowered.

If the absolute value of the AC voltage VCT increases, the base potential of the transistor 49 rises and the electric current flowing through the transistor 49 is reduced. Consequently, the power consumption of the load circuit 48 may be kept at a substantially constant value without depending on the AC voltage VCT.

In this manner, since the detection circuit of the third embodiment allows the electric current to be flowed between the input terminals at all the phases, the operations of the dimmer may be stabilized in addition to the effects and advantages of the detection circuit according to the first embodiment.

Since the detection circuit of the embodiment has a constant power characteristic in which the electric current decreases with increase in absolute value of the AC voltage and increases with decrease in absolute value of the AC voltage, increase in power consumption may be reduced.

Although the embodiments have been described, the configurations are not limited to the embodiments, and various modifications are applicable.

For example, the load circuit composed of the resistance 27 and the switch 29 in the first circuit 19 may be configured to flow the electric current during the period in which the transistor 28 is in the OFF state in the first circuit 19 and to disconnect the electric current when the transistor 28 is in the ON state. The switch 29 may be turned ON or OFF in all the phases.

The switching element 25 only have to be the normally-on type element, and HEMT may be used, in addition to MOSFET. The HEMT is not limited to the GaN system HEMT. For example, a semiconductor element formed by using a semiconductor (wide band gap semiconductor) having a wide band gap such as Silicon Carbide (SiC) or Gallium nitride (GaN), or diamond on a semiconductor substrate is also applicable. Here, the wide band gap semiconductor means a semiconductor having a wider band gap than gallium arsenide (GaAs) having a band gap of approximately 1.4 eV. Included are, for example, a semiconductor having a band gap of 1.5 eV or larger, gallium phosphide (GaP, band gap, approximately 2.3 eV), gallium nitride (GaN, a band gap of approximately 3.4 eV), diamond (C, a band gap of approximately 5.27 eV), aluminum nitride (AlN, a band gap of approximately 5.9 eV), and silicon carbide (SiC). When equalization of the pressure resistances is wanted, such a wide band gap semiconductor element may be downsized to a size smaller than the silicon semiconductor element, so that downsizing of the detection circuit is enabled.

Although several embodiments and the examples of the invention have been described, these embodiments or the examples are presented as examples and are not intended to limit the scope of the invention. These novel embodiments or the examples may be implemented in other various modes, and various omissions, replacements, and modifications may be made without departing the scope of the invention. The embodiments or examples and the modifications are included in the scope and gist of the invention, and are included in the invention described in claims and in the equivalent range.

What is claimed is:

1. A detection circuit comprising:
a first circuit configured to be turned OFF when an AC voltage to be input to a pair of input terminals is smaller than a prescribed value, and turned ON when the AC voltage is equal to or higher than the prescribed value, the AC voltage subjected to a leading edge control or a trailing edge control by a dimmer or having a continuous phase without passing through the dimmer;
a second circuit configured to detect whether the AC voltage is an AC voltage leading-edge controlled by a dimmer, an AC voltage trailing-edge controlled by the dimmer, or an AC voltage having a continuous phase on the basis of at least any one of the voltage of the first circuit and a gradient of the AC voltage of the first circuit when the first circuit is switched ON while the first circuit is in the OFF state.

2. The detection circuit according to claim 1, wherein the second circuit detects a phase continuity of the AC voltage on the basis of a time width of a period in which the first circuit is in the OFF state.

3. The detection circuit according to claim 2, wherein the second circuit compares a voltage of the first circuit and a smoothed voltage generated by converting the AC voltage to a DC voltage and detects whether the AC voltage is the leading-edge controlled AC voltage or the trailing-edge controlled AC voltage.

4. The detection circuit according to claim 1, wherein the second circuit detects the phase continuity of the AC voltage on the basis of a gradient of the rising AC voltage when the first circuit is turned ON.

5. The detection circuit according to claim 2, wherein the second circuit detects whether the AC voltage is the leading-edge controlled AC voltage or the trailing-edge controlled AC voltage on the basis of a gradient of the rising AC voltage when the first circuit is turned ON.

6. The detection circuit according to claim 1, wherein the first circuit further includes a load circuit configured in such a manner that a flowing electric current decreases with increase in the AC voltage and the flowing electric current increases with decrease in the AC voltage.

7. The detection circuit according to claim 6, wherein in the load circuit, an electric current flowing through the pair of input terminals and the AC voltage in an ON state present a constant power characteristic.

8. The detection circuit according to claim 1, wherein the first circuit is configured to be symmetry with respect to the pair of input terminals.

9. A detection method comprising:
comparing an AC voltage and a prescribed value; and
detecting whether the AC voltage is an AC voltage leading-edge controlled by a dimmer, an AC voltage trailing-edge controlled by the dimmer, or an AC voltage having a continuous phase on the basis of at least any one of a value and a gradient of the AC voltage when the AC voltage is increased to a level equal to or higher than the prescribed value while the AC voltage is smaller than the prescribed value.

10. The detection method according to claim 9, wherein a phase continuity of the AC voltage is detected on the basis of a time width of a period in which the AC voltage is smaller than the prescribed value.

11. The detection method according to claim 10, comprising:
detecting whether the AC voltage is the leading-edge controlled AC voltage or the trailing-edge controlled AC voltage by comparing the AC voltage and a smoothed voltage generated by converting the AC voltage to a DC voltage.

12. The detection method according to claim 9, comprising:
detecting the phase continuity of the AC voltage on the basis of a gradient of the AC voltage when the AC voltage rises to a value equal to or larger than the predetermined value.

13. The detection method according to claim 10, comprising:
detecting whether the AC voltage is the leading-edge controlled AC voltage or the trailing-edge controlled AC voltage on the basis of the gradient of the AC voltage when the AC voltage rises to a level equal to or higher than the prescribed value.

14. The detection method according to claim 9, wherein a flowing electric current decreases with increase in the AC voltage and the flowing electric current increases with decrease in the AC voltage.

15. The detection method according to claim 9, wherein the electric current and the AC voltage present a constant power characteristic.

16. A method of detecting a presence and a type of dimmer control with first and second circuits connected between a power supply and a lighting device, comprising:
comparing an AC voltage supplied to a pair of input terminals of the first circuit with a prescribed value;
detecting the presence of dimmer control and if present also the type of dimmer control based on at least any one of a value and a gradient of the AC voltage when the AC voltage is increased to a level equal to or higher than the prescribed value from a level where the AC voltage is smaller than the prescribed value.

17. The method of claim 16, wherein the dimmer control is detected to be present if a time width of a period in which the AC voltage is smaller than the prescribed value is greater than a predetermined width.

18. The method of claim 16, wherein the dimmer control is detected to be present based on a gradient of the rising AC voltage when the AC voltage rises to a value equal to or larger than the predetermined value.

19. The method of claim 17, wherein the type of dimmer control is detected based on a magnitude of the gradient.

20. The method of claim 16, further comprising:
turning OFF the first circuit when the AC voltage is smaller than the prescribed value; and
turning ON the first circuit when the AC voltage is equal to or higher than the prescribed value,
wherein the presence of dimmer control and if present also the type of dimmer control are detected based on at least any one of a value and a gradient of the AC voltage when the first circuit is switched from an OFF state to an ON state.
